(19) United States
(12) Patent Application Publication
(10) Pub. No.: US 2026/0332496 A1
(43) Pub. Date: Oct. 22, 2026

(54) OBTAINING ENERGY ANALYTICS FOR DATA NETWORKS

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/297,350

(22) Filed: Aug. 12, 2025

(51) Int. Cl. H04L 43/08; H04L 67/02

(52) U.S. Cl. CPC H04L 43/08; H04L 67/02

(57) ABSTRACT

Various aspects of the present disclosure relate to obtaining energy analytics for data networks (DNS). A network entity, such as a vertical application layer (VAL) server or other service consumer, transmits a hypertext transfer protocol (HTTP) request for energy analytics associated with one or more DNs to another network entity, such as an application data analytics enablement server (ADAES). The HTTP request indicates a custom operation or a non-custom operation to obtain the energy analytics. The ADAES generates the energy analytics based on the custom operation or the non-custom operation. The ADAES transmits the energy analytics to the VAL server or other service consumer in response to the HTTP request.

### TECHNICAL FIELD

The present disclosure relates to wireless communications, and more specifically to data retrieval.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or Cor AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A network entity (e.g., a vertical application layer (VAL) server, service consumer) for wireless communication is described. The network entity may be configured to, capable of, or operable to perform one or more operations as described herein. For example, the network entity may be configured to, capable of, or operable to transmit a hypertext transfer protocol (HTTP) request for energy analytics associated with one or more data networks (DNS), where the HTTP request indicates a custom operation or a non-custom operation to obtain the energy analytics, and receive, in response to the HTTP request, the energy analytics.

A processor (e.g., a standalone processor chipset, or a component of a network entity) for wireless communication is described. The processor may be configured to, capable of, or operable to perform one or more operations as described herein. For example, the processor may be configured to, capable of, or operable to transmit an HTTP request for energy analytics associated with one or more DNs, where the HTTP request indicates a custom operation or a non-custom operation to obtain the energy analytics, and receive, in response to the HTTP request, the energy analytics.

A method performed or performable by a network entity (e.g., a VAL server, service consumer) for wireless communication is described. The method may include transmitting an HTTP request for energy analytics associated with one or more DNs, where the HTTP request indicates a custom operation or a non-custom operation to obtain the energy analytics, and receiving, in response to the HTTP request, the energy analytics.

In some implementations of the network entity, the processor, and the method described herein, the network entity, the processor, and the method may further be configured to, capable of, or operable to transmit the HTTP request including a POST command, where the custom operation is based on the HTTP request being the POST command. In some implementations of the network entity, the processor, and the method described herein, the POST command indicates an identity of the network entity. In some implementations of the network entity, the processor, and the method described herein, the network entity, the processor, and the method may further be configured to, capable of, or operable to transmit the HTTP request including a GET command, where the non-custom operation is based on the HTTP request being the GET command, and where the non-custom operation is associated with a filter criterion for retrieving the energy analytics. In some implementations of the network entity, the processor, and the method described herein, the network entity, the processor, and the method may further be configured to, capable of, or operable to trigger an update to an energy consumption of the one or more DNs based on the energy analytics satisfying a threshold value.

In some implementations of the network entity, the processor, and the method described herein, the energy analytics includes one or more of an expected application service load associated with the one or more DNs, current data traffic within a geographic area (e.g., geographic location and/or service area) associated with the one or more DNs, expected data traffic within the geographic area associated with the one or more DNs, or a predicted energy consumption associated with the geographic area over a time period for the one or more DNs. In some implementations of the network entity, the processor, and the method described herein, the HTTP request includes one or more parameters that indicate one or more of an identity of an analytics event associated with the energy analytics, a type of the analytics event associated with the energy analytics, a DN access identifier (DNAI) of a user plane access to the one or more DNs, a DN name (DNN) associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. In some implementations of the network entity, the processor, and the method described herein, the network entity is associated with a service consumer, and where the energy analytics is received from an additional network entity associated with an application data analytics enablement (ADAE) server (ADAES).

An network entity (e.g., an ADAES) for wireless communication is described. The network entity may be configured to, capable of, or operable to perform one or more operations as described herein. For example, the network entity may be configured to, capable of, or operable to receive an HTTP request for energy analytics associated with one or more DNs, where the HTTP request indicates a custom operation or a non-custom operation to obtain the energy analytics, generate, based on the custom operation or the non-custom operation, the energy analytics, and transmit, in response to the HTTP request, the energy analytics.

A processor (e.g., a standalone processor chipset, or a component of a network entity) for wireless communication is described. The processor may be configured to, capable of, or operable to perform one or more operations as described herein. For example, the processor may be configured to, capable of, or operable to receive an HTTP request for energy analytics associated with one or more DNs, where the HTTP request indicates a custom operation or a non-custom operation to obtain the energy analytics, generate, based on the custom operation or the non-custom operation, the energy analytics, and transmit, in response to the HTTP request, the energy analytics.

A method performed or performable by a network entity (e.g., an ADAES) for wireless communication is described. The method may include receiving an HTTP request for energy analytics associated with one or more DNs, where the HTTP request indicates a custom operation or a non-custom operation to obtain the energy analytics, generating, based on the custom operation or the non-custom operation, the energy analytics, and transmitting, in response to the HTTP request, the energy analytics.

In some implementations of the network entity, the processor, and the method described herein, the network entity, the processor, and the method may further be configured to, capable of, or operable to receive the HTTP request including a POST command, where the custom operation is based on the HTTP request being the POST command. In some implementations of the network entity, the processor, and the method described herein, the POST command is received from an additional network entity and indicates an identity of the additional network entity, and where the network entity, the processor, and the method may further be configured to, capable of, or operable to determine, based on the identity of the additional network entity, that the additional network entity is authorized to request the energy analytics, where the energy analytics is transmitted based on the additional network entity being authorized to request the energy analytics. In some implementations of the network entity, the processor, and the method described herein, the network entity, the processor, and the method may further be configured to, capable of, or operable to receive the HTTP request including a GET command, where the non-custom operation is based on the HTTP request being the GET command, and where the non-custom operation is associated with a filter criterion for retrieving the energy analytics. In some implementations of the network entity, the processor, and the method described herein, the HTTP request indicates the non-custom operation, and where to generate the energy analytics, the network entity, the processor, and the method may further be configured to, capable of, or operable to generate a predicted energy consumption associated with a geographic area over a time period for the one or more DNs based on providing one or more of an expected application service load associated with the one or more DNs, current data traffic within the geographic area associated with the one or more DNs, or expected data traffic within the geographic area associated with the one or more DNs as input to a machine learning model. In some implementations of the network entity, the processor, and the method described herein, an update to an energy consumption of the one or more DNs is based on the energy analytics satisfying a threshold value.

In some implementations of the network entity, the processor, and the method described herein, the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. In some implementations of the network entity, the processor, and the method described herein, the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. In some implementations of the network entity, the processor, and the method described herein, the HTTP request is received from an additional network entity associated with a service consumer, and where the network entity is associated with an ADAES. In some implementations of the network entity, the processor, and the method described herein, the HTTP request indicates the custom operation, and where to generate the energy analytics, the network entity, the processor, and the method may further be configured to, capable of, or operable to transmit, to a data producer, a request for the energy analytics associated with the one or more DNs, and receive, responsive to the request, the energy analytics.

### BRIEF DESCRIPTION OF THE DRAWINGS

FIG. 1 illustrates an example of a wireless communications system in accordance with aspects of the present disclosure.

FIGS. 2 and 3 illustrate examples of signaling diagrams, in accordance with aspects of the present disclosure.

FIG. 4 illustrates an example of an application programming interface (API) architecture, in accordance with aspects of the present disclosure.

FIG. 5 illustrates an example of a network entity in accordance with aspects of the present disclosure.

FIG. 6 illustrates an example of a processor in accordance with aspects of the present disclosure.

FIG. 7 illustrates a flowchart of a method performed by a network entity associated with a service consumer in accordance with aspects of the present disclosure.

FIG. 8 illustrates a flowchart of a method performed by an network entity associated with an ADAES in accordance with aspects of the present disclosure.

### DETAILED DESCRIPTION

A wireless communications system can include a DN, which may be an example of a network infrastructure that provides data services and connectivity to various devices, network entities, and applications in the wireless communications system (e.g., UEs, NEs, a VAL server, ADAES, or other devices and entities). For example, a DN may facilitate the transmission, routing, and processing of data packets between different devices or network entities. A consumer may collect data from the DNs as part of an energy efficiency analytics service. A consumer may be a network entity, service, or application that requests and receives data from one or more DNs for analysis purposes, including, but not limited to, a service consumer (e.g., VAL server), an analytics server (e.g., ADAES), a network management system, or a third-party application that interfaces with the wireless communications system to obtain operational data. The data may include, but is not limited to, network traffic patterns, bandwidth utilization metrics, power consumption measurements, resource allocation statistics, quality of service (QoS) parameters, session duration information, application service load data, and performance indicators related to data transmission and processing activities within the DN infrastructure. However, the consumer may send a standard request for the data, regardless of the use case for the data. Utilizing a standard request may result in inefficient data collection and processing, as the consumer receives data regardless of one or more energy efficiency analytics criterion, leading to unnecessary computational overhead and bandwidth utilization in the wireless communications system.

As described herein, to reduce unnecessary computational overhead and bandwidth utilization related to standard requests for energy analytics, a network entity (e.g., a service consumer device, including a VAL server) can send a request, which may be an HTTP request, for DN energy analytics information, and can receive (e.g., obtain, retrieve) the DN energy analytics information in response to the request. For example, the network entity sends a request that includes a command to an ADAES implementing energy analytics services. The command may be a POST command that indicates the network entity is requesting DN energy analytics information with defined energy efficiency criterion to analyze energy consumption patterns. The ADAES processes the request, generates DN energy analytics, and transmits (e.g., outputs) the DN energy analytics to the network entity. The network entity can analyze the energy consumption data and can trigger an update to an energy consumption of the one or more DNs according to the energy consumption data. Additionally, or alternatively, the command may be a GET command that indicates the network entity is retrieving DN energy analytics information using filter criterion related to one or more defined DN parameters. The ADAE server uses the filter criterion to select and transmit relevant DN energy analytics information to the network entity, and the network entity implements energy efficiency analytics based on the received information to improve network resource allocation and reduce power consumption.

By performing the described techniques, a network entity in a wireless communications system (e.g., a service consumer, VAL server, ADAES) can efficiently implement obtaining energy analytics for DNs, reducing computational overhead and bandwidth utilization related to standard data requests. Enabling the network entity to use different commands (e.g., POST and GET) to obtain DN energy analytics information provides for network entities to either customize the energy analytics with defined energy efficiency criterion or use filter criterion to obtain one or more targeted DN parameters according to use cases and capabilities of the service consumer. Using the different commands may lead to improved resource allocation, enhanced energy consumption management, and improved adaptability of the DNs and the network entity to different network conditions and energy efficiency criterion.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

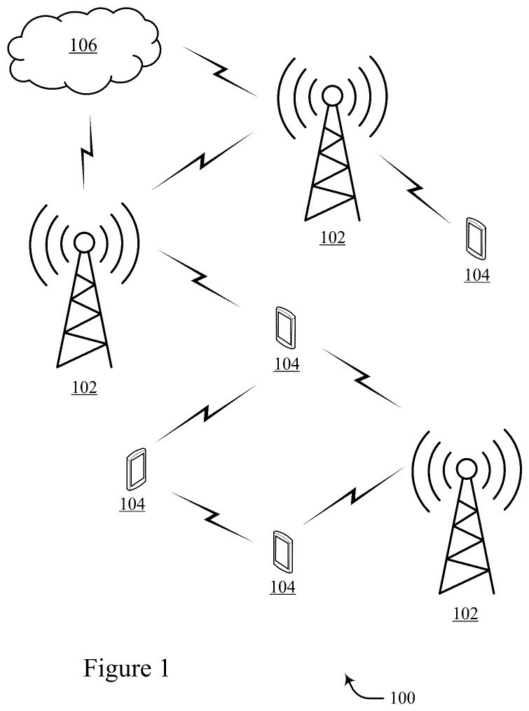

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU, such that the CU may support one or more layers of the protocol stack, and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet DN (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a PDN over one or more backhaul links (e.g., via an S1, N2, N6, or other network interface). The PDN may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. In some implementations, the first numerology (e.g., u=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u=3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., u=0, u=1, u=2, u=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., u=0), which includes 15 kHz subcarrier spacing; a second numerology (e.g., u=1), which includes 30 kHz subcarrier spacing; and a third numerology (e.g., u=2), which includes 60 kHz subcarrier spacing. FR2 may be associated with one or multiple numerologies (e.g., at least 2 numerologies). For example, FR2 may be associated with a third numerology (e.g., u=2), which includes 60 kHz subcarrier spacing; and a fourth numerology (e.g., u=3), which includes 120 kHz subcarrier spacing.

The wireless communications system 100 may include one or more DNs. A DN may be a network infrastructure (e.g., servers, routers, switches, gateways, load balancers, databases, application servers, content delivery networks (CDNs), network management systems, virtualized network functions, software-defined networking controllers, or other hardware or software components) that provides data services and connectivity to various devices, network entities, and applications in the wireless communications system 100. For example, a DN may facilitate the transmission, routing, and processing of data packets between different network components or entities and may serve as a gateway to external networks or services. A DN may include PDNs that provide internet connectivity or networks that deliver one or more services, such as IoT connectivity, multimedia streaming, or edge computing services. In some cases, a DN may be identified by a DNN and may utilize one or more network slices or service types. The DNs can be characterized by DNAIs, which represent access points or locations within the DN where traffic can enter or exit the network. The DN may interface with the CN 106 through various network functions and may support different QoS criterion, security policies, and traffic management capabilities depending on the use case and application.

The wireless communications system 100 may support a DN energy analytics service that provides data and analysis related to energy consumption and efficiency patterns within one or more DNs. The DN energy analytics service may be implemented by network entities, such as an ADAES or other analytics platforms that collect, process, and analyze energy-related data from DNs to generate actionable information for improving network efficiency and energy management. In some cases, the DN energy analytics service may utilize machine learning models, statistical analysis, or other computational techniques to generate (e.g., determine, identify, derive) energy consumption patterns, predict future energy usage, and identify opportunities for energy efficiency improvements across the DN infrastructure.

The DN energy analytics service may include various types of energy-related information and metrics associated with DN operations. For example, the DN energy analytics service may provide expected application service load data that indicates anticipated computational and processing demands on DN resources over defined time periods. In some cases, the DN energy analytics service may include current and predicted data traffic patterns within geographic areas served by the DNs, which may be used to estimate energy consumption based on network utilization. The DN energy analytics service may also generate predicted energy consumption metrics for defined geographic regions over defined time windows, taking into account factors such as user density, application types, network slice configurations, and historical usage patterns. Additionally, or alternatively, the DN energy analytics service may provide energy efficiency recommendations, power consumption information, and comparative analysis between different DN configurations or operational modes to support network operations and resource allocation determinations.

In some wireless communications systems, a consumer may collect data from the DNS as part of the energy analytics service. The data may include, but is not limited to, network traffic patterns, bandwidth utilization metrics, power consumption measurements, resource allocation statistics, QoS parameters, session duration information, application service load data, and performance indicators related to data transmission and processing activities within the DN infrastructure. However, the consumer may send a standard request for the data, regardless of the use case for the data. Utilizing a standard request may result in inefficient data collection and processing, as the consumer receives data regardless of one or more energy efficiency analytics criterion, leading to unnecessary computational overhead and bandwidth utilization in the wireless communications system.

According to implementations, one or more network entities (e.g., an ADAES and VAL server) are operable to implement various aspects of the techniques described with reference to the present disclosure. A network entity of a service consumer, such as a VAL server, may transmit a request for DN energy analytics (e.g., information) to an ADAES implementing energy analytics services. The request may be an example of an HTTP request, where HTTP is an application layer protocol for transmitting and receiving information. The request includes a command to obtain DN energy analytics, such as a POST command for a custom operation that indicates the network entity is requesting DN energy analytics with defined energy efficiency criterion to analyze energy consumption patterns, or a GET command for a non-custom operation that indicates the network entity is retrieving DN energy analytics using filter criterion related to one or more defined DN parameters. The network entity receives the DN energy analytics in response to the request, and may analyze the energy consumption data to trigger an update to an energy consumption of the one or more DNs according to the energy consumption data. An ADAES that implements DN energy analytics services communicates with service consumer devices, including the network entity, to provide DN energy analytics for deployment at the service consumer devices. The ADAES receives requests for DN energy analytics from service consumer devices, processes the requests according to indicated commands (e.g., POST or GET commands), generates DN energy analytics based on the custom operation or non-custom operation, and transmits the DN energy analytics to the requesting devices.

A network entity may be any device, component, or system that participates in network communications and operations within the wireless communications system 100. Network entities may include hardware devices, software applications, virtualized functions, or combinations thereof that are capable of transmitting, receiving, processing, or managing data within the network infrastructure. In some cases, network entities may perform various roles in facilitating DN energy analytics services and related operations. For example, a network entity may function as a service consumer, such as a VAL server, which may request and utilize DN energy analytics information for VALs and energy management decisions. The service consumer network entity may transmit HTTP requests to obtain energy analytics data and may process the received information to implement energy optimization strategies or trigger updates to energy consumption patterns within one or more DNs. Additionally, or alternatively, a network entity may operate as an analytics service provider, such as an ADAES, which may receive requests for DN energy analytics, process the requests using machine learning models or other analytical techniques, and generate energy consumption predictions and efficiency metrics for transmission to requesting entities. In some cases, a network entity may serve as a data producer, which may collect and provide operational data from DNs, including network performance metrics, traffic patterns, and resource utilization information that may be used in energy analytics calculations. The network entities may communicate with each other through various interfaces and protocols to enable the collection, processing, and distribution of DN energy analytics information across the wireless communications system 100.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

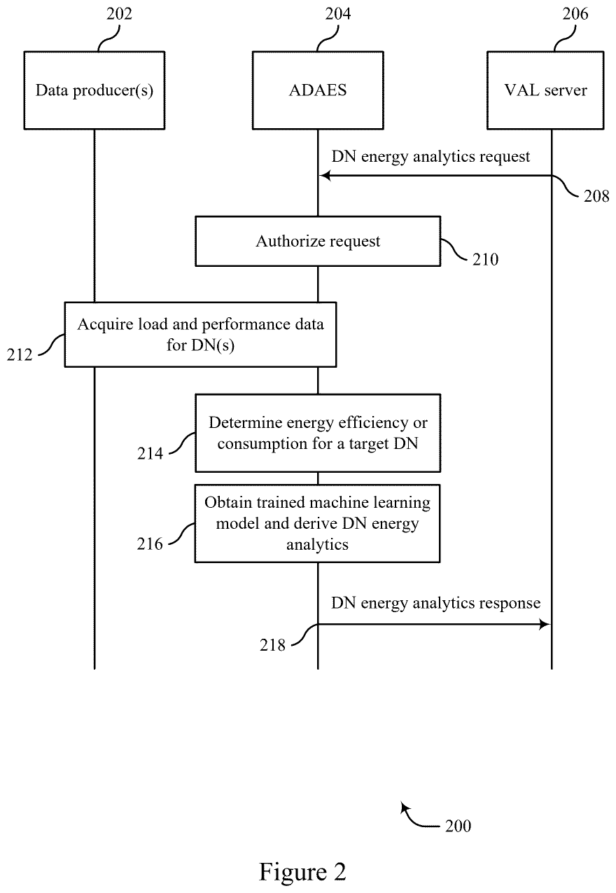

FIG. 2 illustrates an example of a signaling diagram 200 in accordance with aspects of the present disclosure. In some examples, the signaling diagram 200 implements or is implemented by aspects of the wireless communications system 100. The signaling diagram 200 may implement or be implemented by one or more devices (e.g., NEs, network entities, or other devices or entities), including a data producer 202, an ADAES 204, and a VAL server 206, which may be examples of or may be implemented by NEs 102 and/or network entities, as described with reference to FIG. 1. For example, the signaling diagram 200 may illustrate an example of DN energy analytics retrieval and processing for one or more DNs. Alternative examples of the following may be implemented, where some processes are performed in a different order than described or are not performed. In some cases, processes may include additional features not mentioned below, or further processes may be added.

The signaling diagram 200 may include at least one data producer 202. The data producer 202 may be a source of operational data from DNs, including network performance metrics, traffic patterns, and resource utilization information, among other example data. The data producer 202 may include various network entities and/or network components, such as an edge enablement server (EES), an edge application server (EAS), an analytics-application data repository function (A-ADRF), one or more DNs, or other network entities that collect and provide data related to DN operations. The data producer 202 may gather information that indicates application service loads, traffic schedules, and performance indicators that can be utilized to assess energy consumption patterns at the DNs.

The ADAES 204 may process requests for DN energy analytics and coordinate data collection from various sources within a network, such as the data producer 202. The ADAES 204 may implement machine learning models and analytical algorithms to generate energy consumption predictions and efficiency metrics based on collected data. The ADAES 204 may also handle authorization processes to ensure that requesting entities are authorized to access DN energy analytics services and corresponding data.

The VAL server 206 may be a service consumer that requests DN energy analytics for use in vertical applications and energy management decisions. The VAL server 206 may utilize the received analytics data to determine resource allocations, application server migration, or other energy optimization strategies for DNs or other data producers.

The signaling diagram 200 may illustrate an example of a procedure for DN energy analytics request and response processing. At 208, the VAL server 206 transmits a DN energy analytics request to the ADAES 204 to perform analytics on DN energy consumption or efficiency for one or more DNs or edge DNs (EDNs). The request may include an event identifier set to “DN energy analytics” and may indicate parameters for a DN service area or subarea and a time window (e.g., duration, time period) for the analytics.

At 210, the ADAES 204 performs an authorization process for the VAL request. The ADAES 204 may verify the identity of the requesting VAL server 206 and check permissions to determine that the VAL server 206 is authorized to access the requested DN energy analytics services.

At 212, the ADAES 204 collects data (e.g., load and performance data) for one or more DNs from the data producer 202. For example, the ADAES 204 may request and receive (e.g., collect, acquire, obtain) the data, including expected application service load and traffic schedules, among other example data, from EASs or VAL servers hosted at serving and target DNs within the service area. The data may include traffic schedule reports and other operational metrics for ongoing or future sessions within the service area.

At 214, the ADAES 204 determines energy efficiency consumption for the target DN based on the data. For example, the ADAES 204 may calculate expected energy consumption or efficiency metrics using the data for defined DNN or DNAI parameters from the original request.

At 216, the ADAES 204 obtains a trained machine learning model and derives DN energy analytics. For example, the ADAES 204 may obtain a trained ML model and perform analytics to determine a predicted energy consumption for a target geographic region or service area and time period. The analytics outputs may include predicted energy consumption or efficiency metrics for the specified DNN or DNAI parameters.

At 218, the ADAES 204 transmits a DN energy analytics response including the energy consumption or efficiency analytics output data to the VAL server 206. The response provides the VAL server 206 with analytical results that can be used for energy management and optimization determinations.

Based on the analytics data, the VAL server 206 may use the information to trigger proactive energy optimization actions. For example, the VAL server 206 may initiate application server migration to a different edge cloud or centralized cloud to reduce energy consumption if the predicted consumption exceeds a defined threshold value. Additionally, or alternatively, the VAL server 206 may trigger application server offboarding and instantiation of new servers at target edge or centralized cloud locations to reduce energy consumption.

FIG. 3 illustrates an example of a signaling diagram 300 in accordance with aspects of the present disclosure. In some examples, the signaling diagram 300 implements or is implemented by aspects of the wireless communications system 100 and the signaling diagram 200. The signaling diagram 300 may implement or be implemented by one or more devices (e.g., NEs or network entities), including a service consumer 302 and an ADAES 304, which may be examples of or may be implemented by NEs 102 and/or network entities, as described with reference to FIG. 1. For example, the signaling diagram 300 may illustrate an example of DN energy analytics retrieval by the service consumer 302 (e.g., a VAL server) using HTTP requests with different operations. Alternative examples of the following may be implemented, where some processes are performed in a different order than described or are not performed. In some cases, processes may include additional features not mentioned below, or further processes may be added.

The service consumer 302 may initiate requests for DN energy analytics to perform various energy management tasks. The service consumer 302 may include or may be implemented by various devices or network entities, such as VAL servers, EAS servers, or EES servers. The ADAES 304 may handle requests from service consumer devices (e.g., the service consumer 302) for DN energy analytics, interpret criterion of the service consumer devices, and facilitate the generation and retrieval of energy analytics information from one or more DNs.

At 306, the service consumer 302 transmits an HTTP request for energy analytics associated with one or more DNs to the ADAES 304. The HTTP request indicates an operation to obtain the energy analytics. The operation may include a custom operation, such as a POST command, or a non-custom operation, such as a GET command. If the HTTP request includes a POST command, then the operation is a custom operation that enables the service consumer 302 to request DN energy analytics with defined energy efficiency criterion to analyze energy consumption patterns. If the HTTP request includes a GET command, then the operation is a non-custom operation, and the energy analytics is obtained using filter criterion related to defined or configured DN parameters. The filter criterion may include parameters or information elements that define a scope and one or more characteristics of the energy analytics to be obtained, such as geographic area boundaries, time periods, DNN identifiers, DNAI values, energy metric types (e.g., power usage effectiveness, energy use intensity, carbon intensity), confidence level thresholds, or DN characteristics that determine which energy analytics information is selected and returned in the response. In some examples, the ADAES 304 may be configured (e.g., preconfigured) with the filter criterion. In some other examples, the ADAES 304 may determine the filter criterion using analytics parameters included in the HTTP request. For example, the ADAES 304 may use the parameters to identify and select relevant energy analytics information that matches the parameters, such as DN characteristics, geographic boundaries, temporal constraints, or energy measurement types. The HTTP request may include information about analytics parameters, such as DNAI, DNN, geographic area, time period, and energy metrics for predicting energy consumption.

At 308, the ADAES 304 generates the energy analytics based on the custom operation or non-custom operation indicated in the HTTP request. For custom operations, the ADAES 304 may verify the identity of the requesting service consumer 302 and determine authorization to access DN energy analytics services. The ADAES 304 may request performance data from one or more DNs and calculate energy efficiency and consumption analytics using trained machine learning models. For non-custom operations, the ADAES 304 may apply the filter criterion to select and generate relevant DN energy analytics information according to the defined parameters.

At 310, the ADAES 304 transmits a response to the service consumer 302. The response includes the energy analytics that is available for the specified DNs. For example, the information may include expected application service load, current and predicted data traffic patterns, predicted energy consumption metrics, and/or energy efficiency recommendations to enable the service consumer 302 to improve energy efficiency at the DNS.

In some cases, at 312, the service consumer 302 may trigger an update to energy consumption of the one or more DNs based on the received analytics data satisfying threshold values. For example, the service consumer 302 may initiate migration of application workloads from high-energy consumption DNs to relatively more energy-efficient DNs, or may trigger dynamic scaling of computational resources to reduce power usage during periods of predicted low demand. Additionally, or alternatively, the service consumer 302 may adjust network routing policies to distribute traffic loads more evenly across DNs, thereby improving energy utilization across network infrastructure.

The custom operations use an HTTP POST request to convey information elements to obtain the DN energy analytics, while the non-custom operations use an HTTP GET request by introducing the filter criterion with a set of information elements. The use of different commands (e.g., POST and GET) provides for network entities, including the ADAES 304, to either customize the energy analytics with defined energy efficiency criterion or to use filter criterion to obtain targeted DN parameters according to use cases and capabilities of the service consumer 302. Using the different commands may lead to improved resource allocation, enhanced energy consumption management, and improved adaptability of the DNs to different network conditions and energy efficiency criterion.

In some cases, a DN energy analytics service exposed by a VAL server, EAS, or EES, referred to as an SS_ADAE_DN_energy_analytics service, enables a service consumer 302 to request the ADAES 304 to provide DN energy efficiency and consumption analytics. The service operations defined for the SS_ADAE_DN_energy_analytics API are shown in Table 1.

TABLE 1
Service operations of the SS_ADAE_DN_energy_analytics API

| Service Operation | | |
|---|---|---|
| Name | Description | Initiated by |
| SS_ADAE_DN_ | This service operation enables | e.g., VAL |
| energy_analytics_ | a service consumer to obtain | server |
| Request | DN energy efficiency and | |
| | consumption analytics. | |

A service consumer 302 uses the SS_ADAE_DN_energy_analytics_Request service operation to perform an ADAE DN energy analytics request at the ADAES 304. The ADAE DN energy analytics request procedure is supported by the SS_ADAE_DN_energy_analytics_Request service operation.

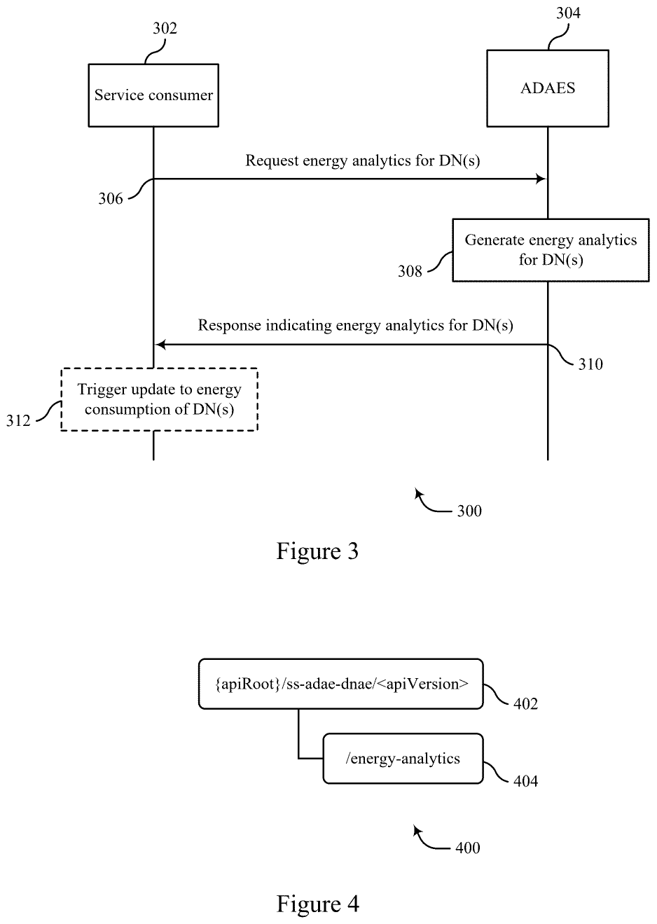

To request the ADAES 304 to provide the DN energy efficiency and consumption analytics by performing the DN energy analytics service, the service consumer 302 transmits the HTTP POST request, at 306 (e.g., custom operation: “ADAE DN energy analytics”), with a request uniform resource indicator (URI) set to “{apiRoot}/ss-adae-dnea/<apiVersion>/energy-analytics” and with a body including a data type DNEnergyAnalytics, which is described in further detail with respect to FIG. 4. Upon receipt of the HTTP POST request, the ADAES 304 verifies an identity of the service consumer 302. The HTTP POST request may include the identity of the service consumer 302. The ADAES 304 determines if the service consumer 302 is authorized to request the DN energy efficiency and consumption analytics. If the HTTP POST request is handled successfully and if the service consumer 302 is authorized, then the ADAES 304 requests performance data from one or more DNs. The ADAES 304 responds to the service consumer 302 with an HTTP “200 OK” response code with the reponse body including a data type DNEnergyAnalytics that indicates the DN energy analytics.

In some cases, the ADAES 304 calculates the energy efficiency and consumption analytics by using one or more trained machine learning model based on an AIMLES_MLModelTraining service, obtained from an artificial intelligence machine learning enablement (AIMLE) server. The AIMLES_MLModelTraining service may be a service for training and deploying machine learning models for network analytics applications, while the AIMLE server may serve as a centralized repository and management platform for artificial intelligence and/or machine learning models used across various network functions or network entities. The ADAES 304 may utilize the trained machine learning model by providing input data, such as historical traffic patterns, current network load metrics, and DN operational parameters, to generate predictive analytics outputs, including forecasted energy consumption levels, efficiency improvement recommendations, and resource utilization projections for defined time periods and geographic areas. If the HTTP POST request is not handled successfully or if the service consumer 302 is not authorized, then the ADAES 304 responds with an error response.

The SS_ADAE_DN_energy_analytics service may use a defined API, which may be referred to as an SS_ADAE_DN_energy_analytics API. The API URI of the SS_ADAE_DN_energy_analytics API may be {apiRoot}/<apiName>/<apiVersion>. The request URIs used in HTTP requests may have a resource URI structure, such as {apiRoot}/<apiName>/<apiVersion>/<apiSpecificSuffixes>, with one or more components. The components may include, but are not limited to, an {apiRoot}, an <apiName> (e.g., “ss-adae-dnea”) an <apiVersion> (e.g., “v1”), and/or an <apiSpecificSuffixes>. In some cases, a service producer (e.g., the ADAES 304) may be a service capability exposure function (SCEF) and the service consumer (e.g., an ADAE service consumer, including a VAL server) may be a services capability server (SCS) and/or application server.

Table 2 provides an overview of the custom operations and applicable HTTP methods defined for the SS_ADAE_DN_energy_analytics API.

TABLE 2
Custom operations without associated resources

| | Custom | Mapped | |
|---|---|---|---|
| Operation | operation | HTTP | |
| name | URI | method | Description |
| ADAE DN | /energy- | POST | Used by the service consumer |
| energy | analytics | | 302 to request the ADAES |
| analytics | | | 304 to perform DN |
| | | | energy analytics service. |

The custom operation enables the service consumer 302 to request the ADAES 304 to provide DN energy efficiency and consumption analytics. The custom operation supports response data structures and response codes specified in Tables 3, 4, 5, and 6. In some cases, P may indicate a presence, including M for mandatory, C for conditional, and O for optional. Cardinality refers to a number (e.g., amount, numerical quantity) of elements or occurrences for a parameter or field. The cardinality column in the tables provides information that indicates how many instances of an item are present, including 1 for one instance, 0 . . . 1 for zero or one instance (e.g., optional, but no more than one), 0 . . . N or 0 . . . : for zero to many instances (e.g., any number, including none), 1 . . . N or 1 . . . : for one to many instances (e.g., at least one, but can be more), and M . . . N for a defined range, where M is the minimum and N is the maximum number of instances.

TABLE 3
Data structures supported by the POST
request body on the resource

| Data type | P | Cardinality | Description |
|---|---|---|---|
| DNEnergy | M | 1 | Includes information to trigger |
| Analytics | | | DN Energy Analytics service. |

TABLE 4
Data structures supported by the POST
response body on the resource

| | | | Response | |
|---|---|---|---|---|
| Data type | P | Cardinality | codes | Description |
| DNEnergy | | | 200 OK | Successful case. The DN |
| Analytics | | | | energy analytics service |
| | | | | is performed. |
| N/A | | | 307 | Temporary redirection. |
| | | | Temporary | Ther esponse includes a |
| | | | redirect | location header field |
| | | | | including an alternative |
| | | | | URI of the resource |
| | | | | located in an alternative |
| | | | | ADAES 304. |
| N/A | | | 308 | Permanent redirection. |
| | | | Permanent | Ther esponse includes a |
| | | | redirect | location header field |
| | | | | including an alternative |
| | | | | URI of the resource |
| | | | | located in an alternative |
| | | | | ADAES 304. |

NOTE:
One or more additional defined or configured HTTP error status codes for the HTTP POST method also apply.

TABLE 5
Headers supported by the 307 response code on the resource

| Name | Data type | P | Cardinality | Description |
|---|---|---|---|---|
| Location | string | M | 1 | Includes an alternative |
| | | | | target URI located in an |
| | | | | alternative ADAES 304. |

TABLE 6
Headers supported by the 308 response code on the resource

| Name | Data type | P | Cardinality | Description |
|---|---|---|---|---|
| Location | string | M | 1 | Includes an alternative |
| | | | | target URI located in an |
| | | | | alternative ADAES 304. |

The API may support an application data model. For example, Table 7 specifies the data types defined for the SS_ADAE_DN_energy_analytics API.

TABLE 7
SS_ADAE_DN_energy_analytics API specific data types

| Data type | Description |
|---|---|
| DNEnergy Analytics | Represents the energy analytics |
| | for a DN. |
| EnergyMetrics | Represents the metrics of the energy |
| | for a DN. |

Table 8 specifies data types reused by the SS_ADAE_DN_energy_analytics API from other operations and a short description of use within the SS_ADAE_DN_energy_analytics API.

TABLE 8
SS_ADAE_DN_energy_analytics API reused data types

| Data type | Comments |
|---|---|
| AnalyticsType | Identifies type of the analytics. |
| Dnai | Identifies a user plane access to |
| | one or more DN(s). |
| Dnn | Identifies a DNN. |
| LocationArea | Represents the user location area. |
| Time Window | Represents a time interval (e.g., |
| | period, window). |
| ReportingRequirements | Identifies the criterion (e.g., |
| | requirements) for the energy |
| | analytics reporting. |
| Uinteger | Used to represent integer attributes |
| | within measurement data. |

Tables 9 and 10 define one or more structures to be used in resource representations.

TABLE 9
Definition of type DNEnergyAnalytics

| Attribute | | | | |
|---|---|---|---|---|
| name | Data type | P | Cardinality | Description |
| analyticsId | AnalyticsId | M | 1 | Represents the |
| | | | | identity of the |
| | | | | analytics event. |
| analytics | Analytics | M | 1 | Represents the |
| Type | Type | | | type of the |
| | | | | analytics event. |
| dnai | Dnai | C | 0 . . . 1 | Represents the |
| | | | | DNAI of user |
| | | | | plane access to |
| | | | | DN(s) which the |
| | | | | subscription |
| | | | | applies. |
| | | | | (NOTE 1) |
| dnn | Dnn | C | 0 . . . 1 | Represents the |
| | | | | target DNN |
| | | | | which the |
| | | | | subscription |
| | | | | applies. |
| | | | | (NOTE 1) |
| energy | Energy | O | 0 . . . 1 | In the request, |
| Metrics | Metrics | | | represents the |
| | | | | metrics for |
| | | | | predicting the |
| | | | | energy ef- |
| | | | | ficiency and |
| | | | | consumption. |
| | | | | In the response, |
| | | | | represents the |
| | | | | predicted |
| | | | | metrics of the |
| | | | | energy |
| | | | | efficiency and |
| | | | | consumption. |
| profile | string | O | 0 . . . 1 | The characteristics |
| Criteria | | | | of the data |
| | | | | producers to be |
| | | | | used. (NOTE) |
| confLevel | integer | C | 0 . . . 1 | Indicates the |
| | | | | preferred con- |
| | | | | fidence level of |
| | | | | the prediction. |
| | | | | The attribute |
| | | | | may be provided |
| | | | | if the “analytics |
| | | | | Type” attribute |
| | | | | in the request |
| | | | | is set to |
| | | | | “PREDICTIVE.” |
| | | | | Minimum = 0. |
| | | | | Maximum = 100. |
| area | LocationArea | O | 0 . . . 1 | Represents the area |
| | | | | of interest. |
| timeVal | Time Window | O | 0 . . . 1 | Represents the time |
| | | | | validity of the |
| | | | | request. |
| reportReqs | Reporting | O | 0 . . . 1 | Represents the |
| | Requirements | | | reporting criterion |
| | | | | (e.g., requirements). |

NOTE 1:
At least one of the attributes, either “dnai” or “dnn,” may be present.
NOTE 2:
The format of the attribute is up to implementation.

TABLE 10
Definition of type EnergyMetrics

| Attribute name | Data type | P | Cardinality | Description |
|---|---|---|---|---|
| energyUse | Uinteger | O | 0 . . . 1 | Represents energy |
| Intens | | | | use intensity (EUI), |
| | | | | which measures a |
| | | | | total energy |
| | | | | consumption. |
| powUseEffect | Uinteger | O | 0 . . . 1 | Represents power |
| | | | | usage effectiveness |
| | | | | (PUE), which |
| | | | | measures a ratio of |
| | | | | total facility energy |
| | | | | consumption to an |
| | | | | energy consumed |
| | | | | by information |
| | | | | technology (IT) |
| | | | | equipment. |
| specEnergy | Uinteger | O | 0 . . . 1 | Represents specific |
| Cons | | | | energy consumption |
| | | | | (SEC), which |
| | | | | measures an energy |
| | | | | consumed per unit |
| | | | | of output. |
| carbonIntens | Uinteger | O | 0 . . . 1 | Represents carbon |
| | | | | intensity, which |
| | | | | measures an amount |
| | | | | of carbon dioxide |
| | | | | (CO2) emissions per |
| | | | | unit of energy |
| | | | | consumed. |
| energyCost | Uinteger | O | 0 . . . 1 | Represent energy cost |
| | | | | per unit of output or a |
| | | | | defined activity. |
| energyIntens | Uinteger | O | 0 . . . 1 | Represents energy |
| | | | | intensity, which |
| | | | | measures a total |
| | | | | energy consumed |
| | | | | relative to a defined |
| | | | | activity or output. |

The service consumer 302 and the ADAES 304 may use simple data types and enumerations to reference from the defined data structures. The service consumer 302 and the ADAES 304 may support error handling for the SS_ADAE_DN_energy_analytics API.

The service consumer 302 and the ADAES 304 may support non-custom operations for an SS_ADAE_DN_energy_analytics service. The SS_ADAE_DN_energy_analytics service, exposed by a VAL server, EAS, or EES, enables a service consumer 302 to request an ADAES 304 to provide DN energy efficiency analytics or DN energy consumption analytics by using filter criterion. The service operations defined for the SS_ADAE_DN_energy_analytics API are shown in Table 11.

TABLE 11
Service operations of the SS_ADAE_DN_energy_
analytics API

| Service Operation | | Initiated |
|---|---|---|
| Name | Description | by |
| SS_ADAE_DN_ | This service operation | e.g., |
| energy_analytics_ | enables a service con- | VAL |
| Request | sumer 302 to obtain DN | server |
| | energy efficiency | |
| | analytics or DN energy | |
| | consumption analytics. | |

The SS_ADAE_DN_energy_analytics_Request service operation is used by a service consumer 302 to perform an ADAE DN energy analytics request at an ADAES 304. The “SS_ADAE_DN_energy_analytics_Request” service operation supports ADAE DN energy analytics request (e.g., from the service consumer 302 to request ADAE DN energy analytics). To request ADAE DN energy analytics, the service consumer 302 may send an HTTP GET request to the ADAES 304 targeting a URI of the “ADAE DN energy analytics” resource. Upon success, the ADAES 304 may respond with an HTTP “200 OK” status code with the response body including a DNEnergyAnalytics data structure. The ADAES 304 calculates an energy efficiency or energy consumption by using a trained machine learning model based on an AIMLES_MLModelTraining service, obtained from an AIMLE server. Upon failure, the ADAES 304 returns an HTTP status code indicating an error and additional error information in the HTTP GET response body.

In some cases, the SS_ADAE_DN_energy_analytics service may use a defined API, such as an SS_ADAE_DN_energy_analytics API. An API URI of the SS_ADAE_DN_energy_analytics API may be {apiRoot}/<apiName>/<apiVersion>. The request URIs used in HTTP requests may include a defined resource URI structure, such as {apiRoot}/<apiName>/<apiVersion>/<apiSpecificSuffixes>, with one or more components. The components can include, but are not limited to, an {apiRoot}, an <apiName> (e.g., “ss-adae-dnea”), an <apiVersion> (e.g., “v1”), and an <apiSpecificSuffixes>. In some cases, a service producer (e.g., the ADAES 304) performs a role of an SCEF and the service consumer (e.g., the service consumer 302, VAL server) performs a role of an SCS and/or an application server.

TABLE 12
provides an overview of the resources and applicable
HTTP methods.
Table 12: Resources and methods overview

| | | HTTP | |
|---|---|---|---|
| | | method | |
| Resource | Resource URI | or | Description |
| purpose/ | (relative path | custom | (service |
| name | after API URI) | operation | operation) |
| ADAE DN | /energy- | GET | Request the |
| energy | analytics | | ADAE DN |
| analytics | | | energy analytics |
| | | | according to the |
| | | | filtering criterion. |

The “ADAE DN Energy Analytics” resource represents the ADAE DN energy analytics. The resource is defined by a resource URI (e.g., {apiRoot}/ss-adae-dnae/<apiVersion>). The resource may support the resource URI variables defined in Table 13.

TABLE 13
Resource URI variables for this resource

| | Data | |
|---|---|---|
| Name | Type | Definition |
| apiRoot | string | Represents a sequence of zero or more |
| | | Unicode characters encoded using |
| | | UTF-8. The string data type may be |
| | | used to represent text-based informa- |
| | | tion in API requests and responses. |

The GET method may support the URI query parameters specified in Table 14.

TABLE 14
URI query parameters supported by the GET method
on this resource

| Name | Data type | P | Cardinality | Description |
|---|---|---|---|---|
| filt-criteria | DNEnergy | M | 1 | Represents the ADAE |
| | Analytics | | | DN energy analytics |
| | | | | filtering criterion. |
| supported- | Supported | C | 0 . . . 1 | Includes supported |
| features | Features | | | features information, |
| | | | | used to negotiate the |
| | | | | applicability of |
| | | | | optional features. The |
| | | | | query parameter may |
| | | | | be present if feature |
| | | | | negotiation occurs. |

The GET method may support the response data structures and response codes specified in Table 15.

TABLE 15
Data structures supported by the GET response body
on the resource

| | | | Response | |
|---|---|---|---|---|
| Data type | P | Cardinality | codes | Description |
| DNEnergy | M | 1 | 200 OK | Successful case. The |
| Analytics | | | | response body includes |
| | | | | energy efficiently |
| | | | | analytics or energy |
| | | | | consumption analytics. |
| N/A | | | 307 | Temporary redirection. |
| | | | Tem- | The response includes |
| | | | porary | a location header field |
| | | | redirect | including an alternative |
| | | | | target URI of the re- |
| | | | | source located in an |
| | | | | alternative ADAES. |
| | | | | Redirection handling |
| | | | | is defined. |
| N/A | | | 308 | Permanent redirection. |
| | | | Perm- | The response includes |
| | | | anent | a location header field |
| | | | redirect | including an alternative |
| | | | | target URI of the re- |
| | | | | source located in an |
| | | | | alternative ADAES. |
| | | | | Redirection handling |
| | | | | is defined. |

NOTE:
One or more additional defined or configured HTTP error status codes for the HTTP GET method also apply.

TABLE 16
Headers supported by the 307 response code on the
resource

| | Data | | | |
|---|---|---|---|---|
| Name | type | P | Cardinality | Description |
| Location | string | M | 1 | Includes an alternative |
| | | | | URI of the resource |
| | | | | located in an alternative |
| | | | | ADAES. |

TABLE 17
Headers supported by the 308 response code on the
resource

| | Data | | | |
|---|---|---|---|---|
| Name | type | P | Cardinality | Description |
| Location | string | M | 1 | Includes an alternative |
| | | | | URI of the resource |
| | | | | located in an alternative |
| | | | | ADAES. |

The API may support an application data model. For example, Table 18 specifies one or more data types defined for the SS_ADAE_DN_energy_analytics API.

TABLE 18
SS_ADAE_DN_energy_analytics API specific Data Types

| Data type | Description |
|---|---|
| DNEnergy | Represents the energy analytics for a DN. |
| Analytics | |
| EnergyMetrics | Represents the metrics of the energy for a DN. |

Table 19 specifies data types reused by the SS_ADAE_DN_energy_analytics API from other operations and a short description of use within the SS_ADAE_DN_energy_analytics API.

TABLE 19
SS_ADAE_DN_energy_analytics API reused data types

| Data type | Comments |
|---|---|
| AnalyticsType | Identifies type of the analytics. |
| Dnai | Identifies a user plane access |
| | to one or more DN(s). |
| Dnn | Identifies a DNN. |
| LocationArea | Represents the user location area. |
| Time Window | Represents a time interval. |
| Reporting | Identifies the criterion (e.g., requirements) |
| Requirements | for the energy analytics reporting. |
| Uinteger | Used to represent integer attributes within |
| | measurement data. |

The service consumer 302 and/or the ADAES 304 may use a structure in resource representations, as shown in Tables 20 and 21.

TABLE 20
Definition of type DNEnergy Analytics

| Attribute name | Data type | P | Cardinality | Description |
|---|---|---|---|---|
| analyticsId | AnalyticsId | M | 1 | Represents an |
| | | | | identity of the |
| | | | | analytics event. |
| analyticsType | Analytics | M | 1 | Represents a |
| | Type | | | type of the |
| | | | | analytics event. |
| dnai | Dnai | C | 0 . . . 1 | Represents a |
| | | | | DNAI of |
| | | | | user plane ac- |
| | | | | cess to DN(s) |
| | | | | for which the |
| | | | | subscription |
| | | | | applies. |
| | | | | (NOTE 1) |
| dnn | Dnn | C | 0 . . . 1 | Represents a |
| | | | | target DNN |
| | | | | for which the |
| | | | | subscription |
| | | | | applies. |
| | | | | (NOTE 1) |
| energyMetrics | Energy | O | 0 . . . 1 | In the request, |
| | Metrics | | | represents one |
| | | | | or more |
| | | | | metrics for |
| | | | | predicting an |
| | | | | energy ef- |
| | | | | ficiency or |
| | | | | energy con- |
| | | | | sumption. In |
| | | | | the response, |
| | | | | represents |
| | | | | one or more |
| | | | | predicted |
| | | | | metrics of the |
| | | | | energy effic- |
| | | | | iency or energy |
| | | | | consumption. |
| profileCriteria | string | O | 0 . . . 1 | One or more |
| | | | | characteristics |
| | | | | of data |
| | | | | producers to |
| | | | | be used. |
| | | | | (NOTE) |
| confLevel | integer | C | 0 . . . 1 | Indicates a |
| | | | | preferred |
| | | | | confidence |
| | | | | level of a |
| | | | | prediction. |
| | | | | The attribute |
| | | | | is provided |
| | | | | if the |
| | | | | “analytics |
| | | | | Type” attri- |
| | | | | bute in the |
| | | | | request is |
| | | | | set to “PRE- |
| | | | | DICTIVE.” |
| | | | | Minimum = |
| | | | | 0. |
| | | | | Maximum = |
| | | | | 100. |
| area | LocationArea | O | 0 . . . 1 | Represents |
| | | | | an area of |
| | | | | interest. |
| timeVal | Time | O | 0 . . . 1 | Represents |
| | Window | | | a time validity |
| | | | | of the request. |
| reportReqs | Reporting | O | 0 . . . 1 | Represents |
| | Requirements | | | reporting |
| | | | | criterion (e.g., |
| | | | | requirements). |

NOTE 1:
At least one of the attributes, either “dnai” or “dnn,” may be present.
NOTE 2:
The format of the attribute is up to implementation.

TABLE 21
Definition of type EnergyMetrics

| Attribute name | Data type | P | Cardinality | Description |
|---|---|---|---|---|
| energyUseIntens | Uinteger | O | 0 . . . 1 | Represents EUI, |
| | | | | which measures |
| | | | | a total energy |
| | | | | consumption. |
| powUseEffect | Uinteger | O | 0 . . . 1 | Represents PUE, |
| | | | | which measures |
| | | | | a ratio of total |
| | | | | facility energy |
| | | | | consumption to |
| | | | | energy con- |
| | | | | sumed by |
| | | | | IT equipment. |
| specEnergyCons | Uinteger | O | 0 . . . 1 | Represents SEC, |
| | | | | which measures |
| | | | | an energy con- |
| | | | | sumed per unit |
| | | | | of output. |
| carbonIntens | Uinteger | O | 0 . . . 1 | Represents car- |
| | | | | bon intensity, |
| | | | | which measures |
| | | | | the amount of |
| | | | | CO2 emissions |
| | | | | per unit of energy |
| | | | | consumed. |
| energyCost | Uinteger | O | 0 . . . 1 | Represent energy |
| | | | | cost per unit of |
| | | | | output or a defined |
| | | | | activity. |
| energyIntens | Uinteger | O | 0 . . . 1 | Represents energy |
| | | | | intensity, which |
| | | | | measures a total |
| | | | | energy consumed |
| | | | | relative to a defined |
| | | | | activity or output. |

The service consumer 302 and/or the ADAES 304 may use one or more defined simple data types and enumerations to reference from data structures. The service consumer 302 and/or the ADAES 304 may support error handling for the SS_ADAE_DN_energy_analytics API. The service consumer 302 and/or the ADAES 304 may also implement one or more optional features for the SS_ADAE_DN_energy_analytics API, which may be negotiated using a defined extensibility mechanism. The service consumer 302 and/or the ADAES 304 may also implement defined security mechanisms for the SS_ADAE_DN_energy_analytics API.

FIG. 4 illustrates an example of an API architecture 400 in accordance with aspects of the present disclosure. In some examples, the API architecture 400 implements or is implemented by aspects of the wireless communications system 100, the signaling diagram 200, and the signaling diagram 300. The API architecture 400 may be used by network entities (e.g., service consumers, ADAESs) to access DN energy analytics using one or more HTTP requests. For example, the API architecture 400 may provide a structured interface for service consumers to request and obtain energy analytics information from an ADAES. The API architecture 400 includes an API root path 402 and energy analytics 404. The API root path 402 is specified as “{apiRoot}/ss-adae-dnea/” and provides a base URI for accessing the application data analytics enablement DN energy analytics API. The energy analytics 404 is specified as “/energy-analytics” and represents the specific resource endpoint for accessing DN energy analytics information within the API structure.

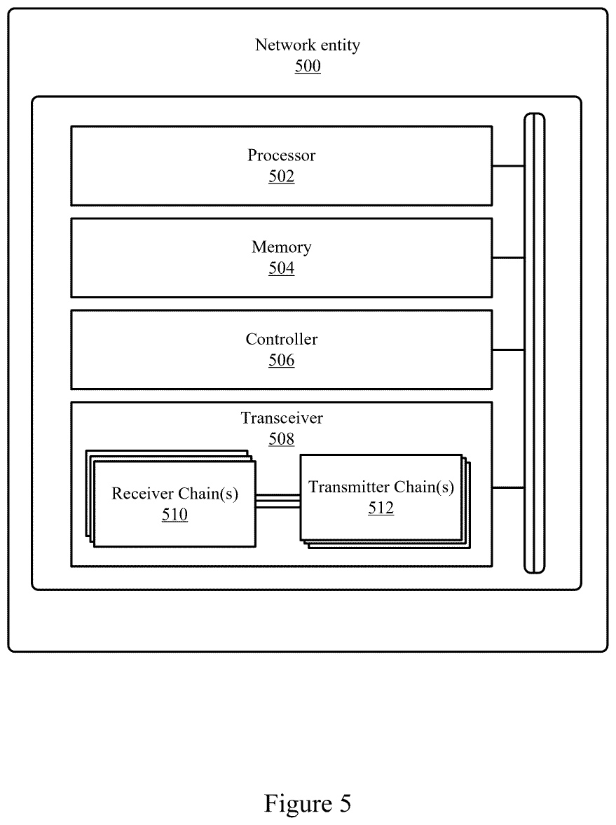

FIG. 5 illustrates an example of a network entity 500 in accordance with aspects of the present disclosure. The network entity 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces. The network entity 500 may be an example of an ADAES, a VAL server, or any other network device.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate-array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the network entity 500 to perform various functions of the present disclosure.

The memory 504 may include volatile or non-volatile memory. The memory 504 may store computer-readable, computer-executable code including instructions when executed by the processor 502 cause the network entity 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured or operable to cause the network entity 500 to perform one or more of the functions described herein (e.g., executing, by the processor 502, instructions stored in the memory 504). For example, the processor 502 may support wireless communication at the network entity 500 in accordance with examples as disclosed herein. The network entity 500 (e.g., a VAL server, service consumer) may be configured to or operable to support a means for transmitting an HTTP request for energy analytics associated with one or more DNs, where the HTTP request indicates a custom operation or a non-custom operation to obtain the energy analytics, and receiving, in response to the HTTP request, the energy analytics.

Additionally, the network entity 500 may be configured to support any one or combination of transmitting the HTTP request including a POST command, where the custom operation is based on the HTTP request being the POST command. Additionally, or alternatively, the network entity 500 may be configured to support the POST command indicates an identity of the network entity 500. Additionally, or alternatively, the network entity 500 may be configured to support transmitting the HTTP request including a GET command, where the non-custom operation is based on the HTTP request being the GET command, and where the non-custom operation is associated with a filter criterion for retrieving the energy analytics. Additionally, or alternatively, the network entity 500 may be configured to support triggering an update to an energy consumption of the one or more DNs based on the energy analytics satisfying a threshold value.

Additionally, or alternatively, the network entity 500 may be configured to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the network entity 500 may be configured to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the network entity 500 may be configured to support the network entity 500 is associated with a service consumer, and where the energy analytics is received from an additional network entity associated with an ADAES.

Additionally, or alternatively, the network entity 500 (e.g., VAL server, service consumer) may support at least one memory (e.g., the memory 504) and at least one processor (e.g., the processor 502) coupled with the at least one memory and configured or operable to cause the network entity 500 to transmit an HTTP request for energy analytics associated with one or more DNs, where the HTTP request indicates a custom operation or a non-custom operation to obtain the energy analytics, and receive, in response to the HTTP request, the energy analytics.

Additionally, the network entity 500 may be configured or operable to support any one or combination of to transmit the HTTP request including a POST command, where the custom operation is based on the HTTP request being the POST command. Additionally, or alternatively, the network entity 500 may be configured or operable to support the POST command indicates an identity of the network entity 500. Additionally, or alternatively, the network entity 500 may be configured or operable to support to transmit the HTTP request including a GET command, where the non-custom operation is based on the HTTP request being the GET command, and where the non-custom operation is associated with a filter criterion for retrieving the energy analytics. Additionally, or alternatively, the network entity 500 may be configured or operable to support to trigger an update to an energy consumption of the one or more DNs based on the energy analytics satisfying a threshold value.

Additionally, or alternatively, the network entity 500 may be configured or operable to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the network entity 500 may be configured or operable to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the network entity 500 may be configured or operable to support the network entity 500 is associated with a service consumer, and where the energy analytics is received from an additional network entity associated with an ADAES.

Additionally, or alternatively, the processor 502 may support wireless communication at a network entity 500 (e.g., an ADAES) in accordance with examples as disclosed herein. The network entity 500 may be configured to or operable to support a means for receiving an HTTP request for energy analytics associated with one or more DNs, where the HTTP request indicates a custom operation or a non-custom operation to obtain the energy analytics, generating, based on the custom operation or the non-custom operation, the energy analytics, and transmitting, in response to the HTTP request, the energy analytics.

Additionally, the network entity 500 may be configured or operable to support any one or combination of receiving the HTTP request including a POST command, where the custom operation is based on the HTTP request being the POST command. Additionally, or alternatively, the network entity 500 may be configured or operable to support the POST command is received from an additional network entity and indicates an identity of the additional network entity, where the network entity 500 may be configured or operable to support determining, based on the identity of the additional network entity, that the additional network entity is authorized to request the energy analytics, where the energy analytics is transmitted based on the additional network entity being authorized to request the energy analytics. Additionally, or alternatively, the network entity 500 may be configured or operable to support receiving the HTTP request including a GET command, where the non-custom operation is based on the HTTP request being the GET command, and where the non-custom operation is associated with a filter criterion for retrieving the energy analytics. Additionally, or alternatively, the network entity 500 may be configured or operable to support the HTTP request indicates the non-custom operation, where to generate the energy analytics, the network entity 500 may be configured or operable to support generating a predicted energy consumption associated with a geographic area over a time period for the one or more DNs based on providing one or more of an expected application service load associated with the one or more DNs, current data traffic within the geographic area associated with the one or more DNs, or expected data traffic within the geographic area associated with the one or more DNs as input to a machine learning model.

Additionally, or alternatively, the network entity 500 may be configured or operable to support an update to an energy consumption of the one or more DNs is based on the energy analytics satisfying a threshold value. Additionally, or alternatively, the network entity 500 may be configured or operable to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the network entity 500 may be configured or operable to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the network entity 500 may be configured or operable to support the HTTP request is received from an additional network entity associated with a service consumer, and where the network entity is associated with an ADAES. Additionally, or alternatively, the network entity 500 may be configured or operable to support the HTTP request indicates the custom operation, and where to generate the energy analytics, the network entity 500 may be configured or operable to support to transmit, to a data producer, a request for the energy analytics associated with the one or more DNs, and receive, responsive to the request, the energy analytics.

Additionally, or alternatively, the network entity 500 (e.g., an ADAES) may support at least one memory (e.g., the memory 504) and at least one processor (e.g., the processor 502) coupled with the at least one memory and configured or operable to cause the network entity 500 to receive an HTTP request for energy analytics associated with one or more DNs, where the HTTP request indicates a custom operation or a non-custom operation to obtain the energy analytics, generate, based on the custom operation or the non-custom operation, the energy analytics, and transmit, in response to the HTTP request, the energy analytics.

Additionally, the network entity 500 may be configured to support any one or combination of to receive the HTTP request including a POST command, where the custom operation is based on the HTTP request being the POST command. Additionally, or alternatively, the network entity 500 may be configured to support the POST command is received from an additional network entity and indicates an identity of the additional network entity, and where the network entity 500 may be configured to support to determine, based on the identity of the additional network entity, that the additional network entity is authorized to request the energy analytics, where the energy analytics is transmitted based on the additional network entity being authorized to request the energy analytics. Additionally, or alternatively, the network entity 500 may be configured to support to receive the HTTP request including a GET command, where the non-custom operation is based on the HTTP request being the GET command, and where the non-custom operation is associated with a filter criterion for retrieving the energy analytics. Additionally, or alternatively, the network entity 500 may be configured to support the HTTP request indicates the non-custom operation, and where to generate the energy analytics, the network entity 500 may be configured to support to generate a predicted energy consumption associated with a geographic area over a time period for the one or more DNs based on providing one or more of an expected application service load associated with the one or more DNs, current data traffic within the geographic area associated with the one or more DNs, or expected data traffic within the geographic area associated with the one or more DNs as input to a machine learning model.

Additionally, or alternatively, the network entity 500 may be configured to support an update to an energy consumption of the one or more DNs is based on the energy analytics satisfying a threshold value. Additionally, or alternatively, the network entity 500 may be configured to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the network entity 500 may be configured to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the network entity 500 may be configured to support the HTTP request is received from an additional network entity associated with a service consumer, and where the network entity 500 is associated with an ADAES. Additionally, or alternatively, the network entity 500 may be configured to support the HTTP request indicates the custom operation, and where to generate the energy analytics, the network entity 500 may be configured to support to transmit, to a data producer, a request for the energy analytics associated with the one or more DNs, and receive, responsive to the request, the energy analytics.

The controller 506 may manage input and output signals for the network entity 500. The controller 506 may also manage peripherals not integrated into the network entity 500. In some implementations, the controller 506 may utilize an operating system such as iOS®, ANDROID®, WINDOWS®, or other operating systems. In some implementations, the controller 506 may be implemented as part of the processor 502.

In some implementations, the network entity 500 may include at least one transceiver 508. In some other implementations, the network entity 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

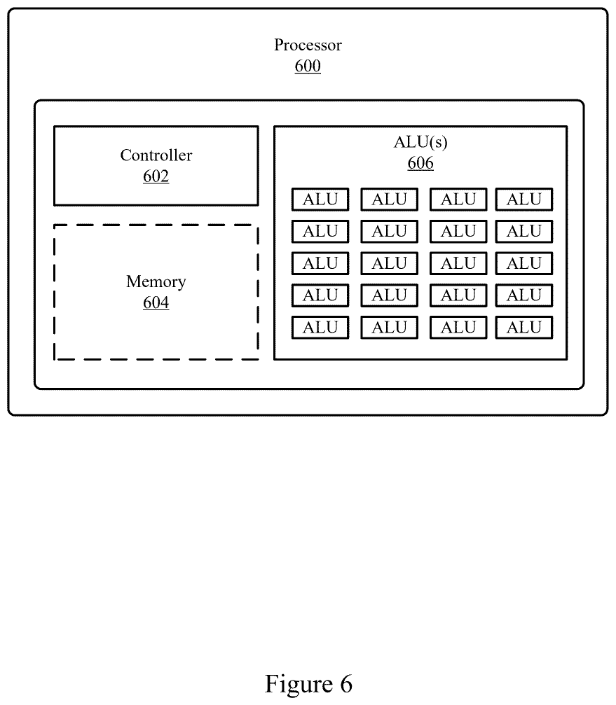

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 (e.g., at a VAL server, service consumer) may be configured to or operable to support at least one controller (e.g., the controller 602) coupled with at least one memory (e.g., the memory 604) and configured or operable to cause the processor to transmit an HTTP request for energy analytics associated with one or more DNs, where the HTTP request indicates a custom operation or a non-custom operation to obtain the energy analytics, and receive, in response to the HTTP request, the energy analytics.

Additionally, the processor 600 may be configured to or operable to support any one or combination of to transmit the HTTP request including a POST command, where the custom operation is based on the HTTP request being the POST command. Additionally, or alternatively, the processor 600 may be configured or operable to support the POST command indicates an identity of the processor 600, and where the energy analytics is received based on the identity of the processor 600 being authorized to request the energy analytics. Additionally, or alternatively, the processor 600 may be configured to support to transmit the HTTP request including a GET command, where the non-custom operation is based on the HTTP request being the GET command, and where the non-custom operation is associated with a filter criterion for retrieving the energy analytics. Additionally, or alternatively, the processor 600 may be configured to support to trigger an update to an energy consumption of the one or more DNs based on the energy analytics satisfying a threshold value.

Additionally, or alternatively, the processor 600 may be configured to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the processor 600 may be configured to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the processor 600 may be configured to support the processor 600 is associated with a service consumer, and where the energy analytics is received from a network entity associated with an ADAES.

A processor 600 (e.g., at an ADAES) may be configured to or operable to support at least one controller (e.g., the controller 602) coupled with at least one memory (e.g., the memory 604) and configured or operable to cause the processor to receive an HTTP request for energy analytics associated with one or more DNs, where the HTTP request indicates a custom operation or a non-custom operation to obtain the energy analytics, generate, based on the custom operation or the non-custom operation, the energy analytics, and transmit, in response to the HTTP request, the energy analytics.

Additionally, the processor 600 may be configured to or operable to support any one or combination of to receive the HTTP request including a POST command, where the custom operation is based on the HTTP request being the POST command. Additionally, or alternatively, the processor 600 may be configured to support the POST command is received from a network entity and indicates an identity of the network entity, and where the processor 600 may be configured or operable to support to determine, based on the identity of the additional network entity, that the network entity is authorized to request the energy analytics, where the energy analytics is transmitted based on the network entity being authorized to request the energy analytics. Additionally, or alternatively, the processor 600 may be configured or operable to support receiving the HTTP request including a GET command, where the non-custom operation is based on the HTTP request being the GET command, and where the non-custom operation is associated with a filter criterion for retrieving the energy analytics. Additionally, or alternatively, the processor 600 may be configured to support the HTTP request indicates the non-custom operation, and where to generate the energy analytics, the processor 600 may be configured to support to generate a predicted energy consumption associated with a geographic area over a time period for the one or more DNs based on providing one or more of an expected application service load associated with the one or more DNs, current data traffic within the geographic area associated with the one or more DNs, or expected data traffic within the geographic area associated with the one or more DNs as input to a machine learning model. Additionally, or alternatively, the processor 600 may be configured to support an update to an energy consumption of the one or more DNs is based on the energy analytics satisfying a threshold value.

Additionally, or alternatively, the processor 600 may be configured to support the energy analytics includes one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs. Additionally, or alternatively, the processor 600 may be configured to support the HTTP request includes one or more parameters that indicate one or more of an identity of an analytics event associated with the energy analytics, a type of the analytics event associated with the energy analytics, a DNAI of a user plane access to the one or more DNs, a DNN associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request. Additionally, or alternatively, the processor 600 may be configured or operable to support the HTTP request is received from a network entity associated with a service consumer, and where the processor 600 is associated with an ADAES. Additionally, or alternatively, the processor 600 may be configured to support the HTTP request indicates the custom operation, and where to generate the energy analytics, the processor 600 may be configured to support to transmit, to a data producer, a request for the energy analytics associated with the one or more DNs, and receive, responsive to the request, the energy analytics.

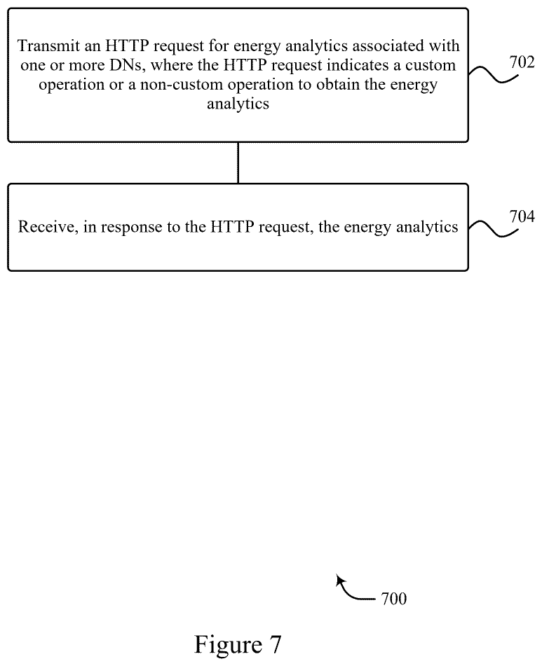

FIG. 7 illustrates a flowchart of a method 700 in accordance with aspects of the present disclosure. The operations of the method may be implemented by a network entity (e.g., a VAL server, service consumer) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 702, the method may include transmitting an HTTP request for energy analytics associated with one or more DNs, where the HTTP request indicates a custom operation or a non-custom operation to obtain the energy analytics. The operations of 702 may be performed in accordance with examples as described herein. In some implementations, aspects of the operations of 702 may be performed by a network entity as described with reference to FIG. 5.

At 704, the method may include receiving, in response to the HTTP request, the energy analytics. The operations of 704 may be performed in accordance with examples as described herein. In some implementations, aspects of the operations of 704 may be performed by a network entity as described with reference to FIG. 5.

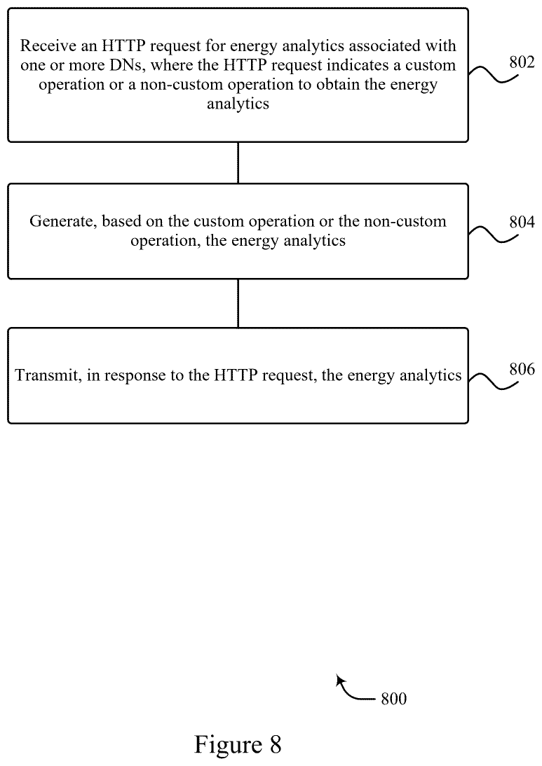

FIG. 8 illustrates a flowchart of a method 800 in accordance with aspects of the present disclosure. The operations of the method may be implemented by a network entity (e.g., an ADAES) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 802, the method may include receiving an HTTP request for energy analytics associated with one or more DNs, where the HTTP request indicates a custom operation or a non-custom operation to obtain the energy analytics. The operations of 802 may be performed in accordance with examples as described herein. In some implementations, aspects of the operations of 802 may be performed by a network entity as described with reference to FIG. 5.

At 804, the method may include generating, based on the custom operation or the non-custom operation, the energy analytics. The operations of 804 may be performed in accordance with examples as described herein. In some implementations, aspects of the operations of 804 may be performed by a network entity as described with reference to FIG. 5.

At 806, the method may include transmitting, in response to the HTTP request, the energy analytics. The operations of 806 may be performed in accordance with examples as described herein. In some implementations, aspects of the operations of 806 may be performed a network entity as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and operable to cause the network entity to:
transmit a hypertext transfer protocol (HTTP) request for energy analytics associated with one or more data networks (DNS), wherein the HTTP request indicates a custom operation or a non-custom operation to obtain the energy analytics; and
receive, in response to the HTTP request, the energy analytics.

2. The network entity of claim 1, wherein the HTTP request comprises a POST command, and wherein the custom operation is based at least in part on the HTTP request being the POST command.

3. The network entity of claim 2, wherein the POST command indicates an identity of the network entity.

4. The network entity of claim 1, wherein the HTTP request comprises a GET command, wherein the non-custom operation is based at least in part on the HTTP request being the GET command, and wherein the non-custom operation is associated with a filter criterion for retrieving the energy analytics.

5. The network entity of claim 1, wherein the at least one processor is further operable to cause the network entity to trigger an update to an energy consumption of the one or more DNs based at least in part on the energy analytics satisfying a threshold value.

6. The network entity of claim 1, wherein the energy analytics comprise one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs.

7. The network entity of claim 1, wherein the HTTP request comprises one or more parameters that indicate one or more of an identity of an analytics event associated with the energy analytics, a type of the analytics event associated with the energy analytics, a DN access identifier (DNAI) of a user plane access to the one or more DNs, a DN name (DNN) associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request.

8. The network entity of claim 1, wherein the network entity is associated with a service consumer, and wherein the energy analytics is received from an additional network entity associated with an application data analytics enablement server (ADAES).

9. A method performed by a network entity, the method comprising:
transmitting a hypertext transfer protocol (HTTP) request for energy analytics associated with one or more data networks (DNS), wherein the HTTP request indicates a custom operation or a non-custom operation to obtain the energy analytics; and
receiving, in response to the HTTP request, the energy analytics.

10. A network entity for wireless communication, comprising:
at least one memory; and
at least one processor coupled with the at least one memory and operable to cause the network entity to:
receive a hypertext transfer protocol (HTTP) request for energy analytics associated with one or more data networks (DNS), wherein the HTTP request indicates a custom operation or a non-custom operation to obtain the energy analytics;
generate, based at least in part on the custom operation or the non-custom operation, the energy analytics; and
transmit, in response to the HTTP request, the energy analytics.

11. The network entity of claim 10, wherein the HTTP request comprises a POST command, and wherein the custom operation is based at least in part on the HTTP request being the POST command.

12. The network entity of claim 11, wherein the POST command is received from an additional network entity and indicates an identity of the additional network entity, and wherein the at least one processor is further operable to cause the network entity to determine, based at least in part on the identity of the additional network entity, that the additional network entity is authorized to request the energy analytics, wherein the energy analytics is transmitted based at least in part on the additional network entity being authorized to request the energy analytics.

13. The network entity of claim 10, wherein the HTTP request comprises a GET command, wherein the non-custom operation is based at least in part on the HTTP request being the GET command, and wherein the non-custom operation is associated with a filter criterion for retrieving the energy analytics.

14. The network entity of claim 10, wherein the HTTP request indicates the non-custom operation, and wherein to generate the energy analytics, the at least one processor is further operable to cause the network entity to generate a predicted energy consumption associated with a geographic area over a time period for the one or more DNs based at least in part on providing one or more of an expected application service load associated with the one or more DNs, current data traffic within the geographic area associated with the one or more DNs, or expected data traffic within the geographic area associated with the one or more DNs as input to a machine learning model.

15. The network entity of claim 10, wherein an update to an energy consumption of the one or more DNs is based at least in part on the energy analytics satisfying a threshold value.

16. The network entity of claim 10, wherein the energy analytics comprise one or more of an expected application service load associated with the one or more DNs, current data traffic within a geographic area associated with the one or more DNs, expected data traffic within the geographic area associated with the one or more DNs, or a predicted energy consumption associated with the geographic area over a time period for the one or more DNs.

17. The network entity of claim 10, wherein the HTTP request comprises one or more parameters that indicate one or more of an identity of an analytics event associated with the energy analytics, a type of the analytics event associated with the energy analytics, a DN access identifier (DNAI) of a user plane access to the one or more DNs, a DN name (DNN) associated with the one or more DNs, one or more energy metrics for predicting an energy consumption associated with a geographic area over a time period for the one or more DNs, one or more characteristics of the one or more DNs, a confidence level associated with predicting the energy consumption associated with the geographic area over the time period for the one or more DNs, the geographic area, the time period, or a criterion associated with the response to the HTTP request.

18. The network entity of claim 10, wherein the HTTP request is received from an additional network entity associated with a service consumer, and wherein the network entity is associated with an application data analytics enablement server (ADAES).

19. The network entity of claim 18, wherein the HTTP request indicates the custom operation, and wherein to generate the energy analytics, the at least one processor is further operable to cause the network entity to:
transmit, to a data producer, a request for the energy analytics associated with the one or more DNs; and
receive, responsive to the request, the energy analytics.

20. A method performed by a network entity, the method comprising:
receiving a hypertext transfer protocol (HTTP) request for energy analytics associated with one or more data networks (DNs), wherein the HTTP request indicates a custom operation or a non-custom operation to obtain the energy analytics;
generating, based at least in part on the custom operation or the non-custom operation, the energy analytics; and
transmitting, in response to the HTTP request, the energy analytics.
